(19) United States
(12) Patent Application Publication
(10) Pub. No.: US 2005/0289083 A1
(43) Pub. Date: Dec. 29, 2005

(54) System and method for authenticating and validating products

(76) Inventors: Francis Tingyu Ngai, Cupertino, CA (US); Benjamin K. Yee, Fremont, CA (US); Jenson Luis, San Jose, CA (US)

Correspondence Address: FORTUNE LAW GROUP, 100 Century Center Ct., San Jose, CA, 95112, US

(21) Appl. No.: 10/853,550

(22) Filed: May 24, 2004

(51) Int. Cl. H04L 9/00

(52) U.S. Cl. 705/67

(57) ABSTRACT

A system for authenticating products delivered in each of a plurality of containers packaged in a package includes a child tag attached to each container and a parent tag attached to the package, the child tags and the parent tag having a parent-child relationship.

### BACKGROUND OF THE INVENTION

The present invention generally relates to systems and methods for authenticating and validating the origin of products and more particularly relates to a system and method for authenticating and validating products which utilizes a parent-child relationship between individual child units contained in a parent container to authenticate and validate the origin of each individual child unit.

The counterfeiting of products continues to be a common concern for manufacturers, wholesalers, retailers, and consumers. The counterfeiting of pharmaceutical products, which by some accounts ranges from two to ten percent of all pharmaceutical products sold in the United States, is of particular concern to the end consumers who rely on these products for their health and well being.

Known systems and methods for preventing the counterfeiting of products include the use of radio frequency identification tags (RFID tags) having stored therein identifying information which may be read and used to authenticate and verify the origin of a product to which the RFID tag is affixed. One such system and method is disclosed in U.S. Pat. No. 6,226,619 entitled “Method and System for Preventing Counterfeiting of High Price Wholesale and Retail Items”. An interrogatable tag such as an RFID tag is attached to an item. The item includes visible indicia for comparison with secret, non-duplicable information stored in the tag designating authenticity. The disclosed system and method is useful for authenticating and verifying single items.

A system for providing product authentication by way of identification and certification of the origin or manufacture of medical supplies, components, and other devices is disclosed in U.S. patent application Publication No. 2002/0188259 entitled “Smart Supplies, Components and Capital Equipment”. The disclosed system relates to capital equipment units, such as systems for providing medical treatment that are associated with smart supplies. The smart supplies are tagged with data carriers which may encode such information as a unique ID for the supply or component, the identification of the supply or component, the identification of the source of the supply or component, the status of whether said supply or component has been previously used, the expiration date of the supply or component, and in the case where the supply or component contains drug, the purity levels of the drug. The capital equipment units or their users then utilize the information to assure quality of any procedure run with the units, by way of improved pre-use checks, certification or the supplies for use, record keeping, inventory control, and charge capture. The disclosed system is useful for authenticating single supplies.

As can be seen, there is a need in the art for a system and method for authenticating and validating products which utilizes a parent-child relationship between individual child units contained in a parent container to authenticate and validate the origin of each individual child unit. Such a system and method preferably provides for authentication and validation of supplies packaged in containers.

### SUMMARY OF THE INVENTION

In accordance with one aspect of the invention, a system for authenticating and validating products utilizes a parent-child relationship between individual child units contained in a parent container to authenticate and validate the origin of each individual child unit.

In another aspect of the invention, the system for authenticating products delivered in each of a plurality of containers packaged in a package includes a child tag attached to each container and a parent tag attached to the package, the child tags and parent tag having a parent-child relationship.

In yet another aspect of the invention, a method for authenticating products delivered in each of a plurality of containers packaged in a package includes the steps of tagging each container with a child tag, and tagging the package with a parent tag, the child tags and parent tag having a parent-child relationship.

In another aspect of the invention, a method for authenticating containers packaged in a package includes the steps of tagging each container with a container tag, writing a container signature to each container tag, tagging the package with a package tag, and writing a package signature to the package tag, the container tags and the package tag having a parent-child relationship.

These and other features, aspects and advantages of the present invention will become better understood with reference to the following drawings, description and claims.

### BRIEF DESCRIPTION OF THE DRAWINGS

FIG. 1 is side elevation view of a container having a radio frequency identification tag attached thereto in accordance with the invention;

FIG. 2 is a schematic representation showing the container radio frequency identification tag being interrogated and having data written thereto in accordance with the invention;

FIG. 3 is a perspective view of a package having a radio frequency identification tag attached thereto in accordance with the invention;

FIG. 4 is a side elevation view of the package having disposed therein a plurality of containers in accordance with the invention;

FIG. 5 is a schematic representation showing the package radio frequency identification tag being interrogated and having data written thereto in accordance with the invention;

FIG. 6 is a schematic representation showing the package radio frequency identification tag being interrogated and verified for authenticity in accordance with the invention;

FIG. 7 is a flow diagram of a method of authenticating and verifying the origin of a product in accordance with the invention; and

FIG. 8 is a flow diagram of a method of tagging and signing container and package radio frequency identification tags in accordance with the invention;

FIG. 9 is a flow diagram of a method of verifying the container and package radio frequency identification tags in accordance with the invention;

FIG. 10 is a flow diagram of a method of creating a signature for the container radio frequency identification tag in accordance with the invention;

FIG. 11 is a flow diagram of a method of creating a signature for the package radio frequency identification tag in accordance with the invention;

FIG. 12 is a flow diagram of a method of verifying the container radio frequency identification tags for authenticity in accordance with the invention;

FIG. 13 is a flow diagram of a method of verifying the package radio frequency identification tags for authenticity in accordance with the invention; and

FIG. 14 is a flow diagram of a method of verifying a parent-child relationship between the container and package radio frequency identification tags in accordance with the invention.

### DETAILED DESCRIPTION OF THE INVENTION

The following detailed description is of the best modes of carrying out the invention. The description is not to be taken in a limiting sense, but is made merely for the purpose of illustrating the general principles of the invention, since the scope of the invention is best defined by the appended claims.

The present invention generally provides a system and method for authenticating and validating products which utilizes a parent-child relationship between individual child units contained in a parent container to authenticate and validate the origin of each individual child unit.

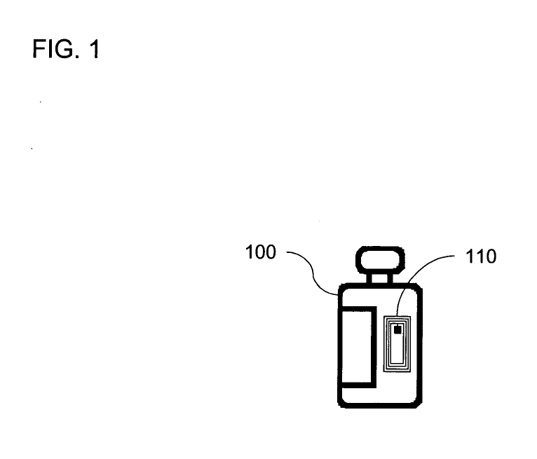

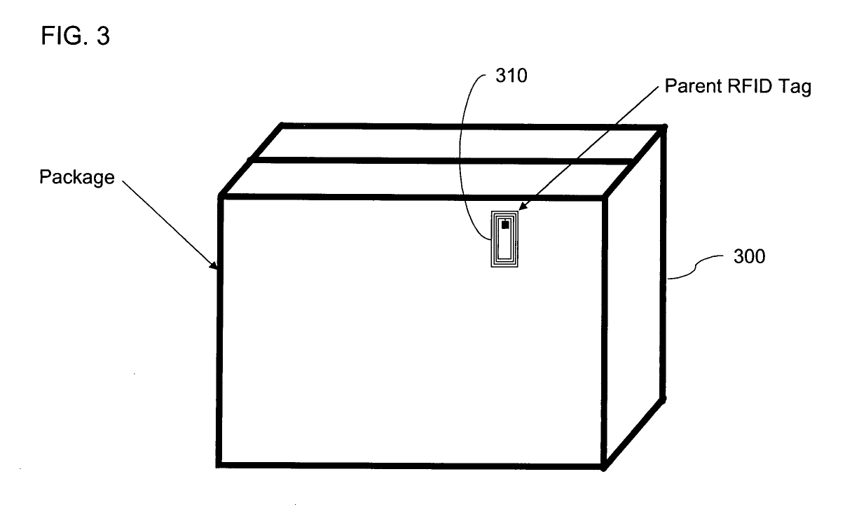

With reference to FIG. 1 and FIG. 3, a container 100 may have attached thereto a container radio frequency identification tag 110 and a package 300 may have attached thereto a package radio frequency identification tag 310. Container radio frequency identification tag 110 and package radio frequency identification tag 310 may include RFID tags from manufacturers such as Texas Instruments, Motorola, Philips, Mitsubishi, Inermec, Micron, and SCS.

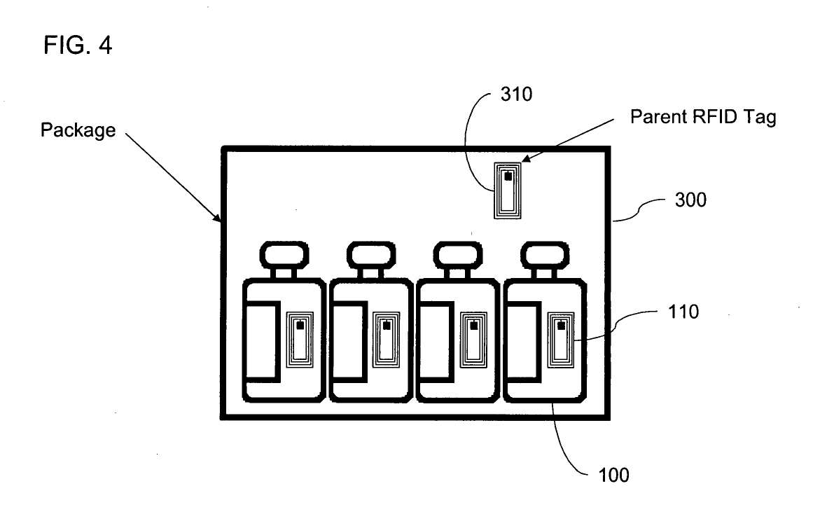

A plurality of containers 100 having attached thereto container radio frequency identification tags 110 may be disposed in a sealed package 300 as shown in FIG. 4. Containers 100 may be packed in sealed package 300 for shipment by the manufacturer of products stored in containers 100. In a preferred embodiment, such products may include pharmaceutical products.

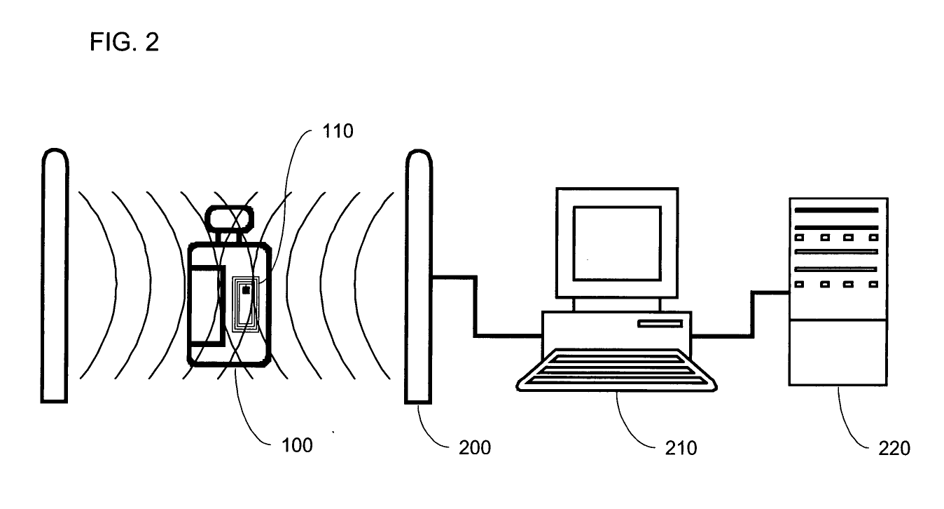

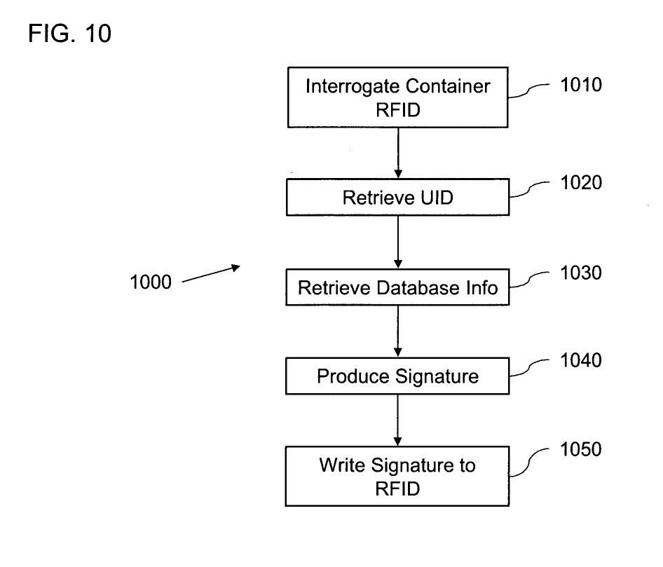

With reference to FIG. 2 and FIG. 10, the container radio frequency identification tags 110 may be interrogated by a radio frequency identification tag reading device 200. Radio frequency identification tag reading device 200 may be coupled to a computer 210 which in turn may be coupled to a database 220. Database 220 may be maintained by the manufacturer of the products stored in containers 100 and accessed by computer 210 in a conventional manner.

A method generally designated 1000 of creating a signature for each container radio frequency identification tag 110 may include a step 1010 in which each container radio frequency identification tag 110 is interrogated. In a step 1020 a unique/universal identifier (UID) may be retrieved from each container radio frequency identification tag 110. The computer 210 may then be operable to retrieve from the database 220 a manufacturer's private key and product data including a National Drug Code (NDC), a lot number, and an expiration date for each container 110 in a step 1030. In a step 1040 the computer 210 may be operable to produce a container signature for each container 100 based upon container UID, the container product data, and the manufacturer's private key. The product data and the signature may be written to each container radio frequency identification tag 110 in a step 1050.

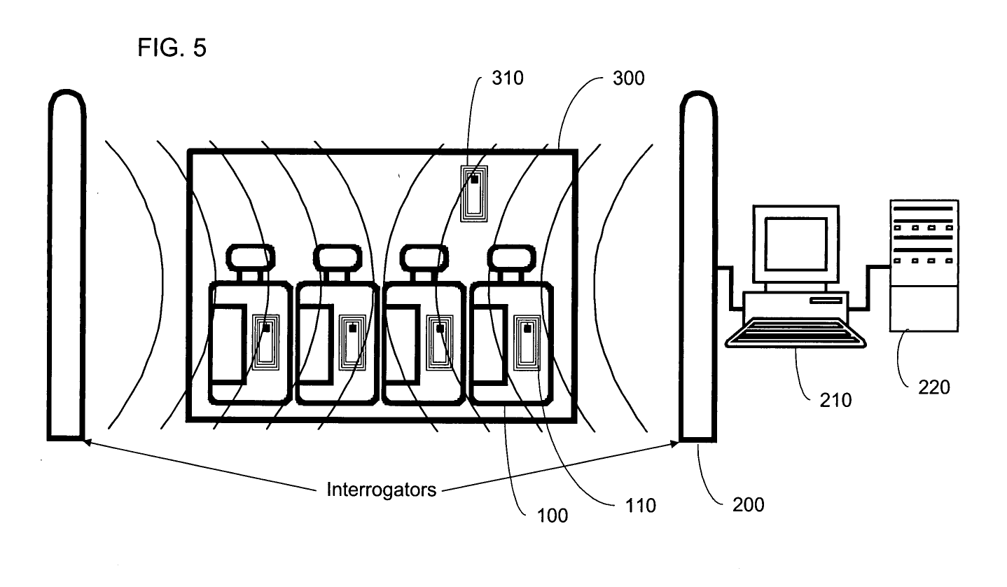

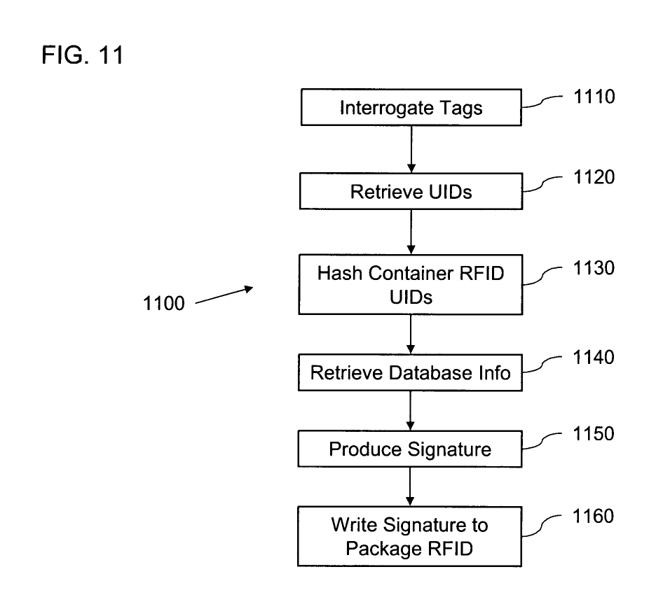

With reference to FIG. 5 and FIG. 11, the package radio frequency identification tags 310 may be interrogated by the radio frequency identification tag reading device 200. Radio frequency identification tag reading device 200 may be coupled to computer 210 which in turn may be coupled to database 220.

A method generally designated 1100 of creating a signature for the package radio frequency identification tag 310 may include a step 1110 in which the package radio frequency identification tag 310 and the container radio frequency identification tags 110 may be interrogated . In a step 1120 the UIDs of the container radio frequency identification tags 110 and a UID of the package radio frequency identification tag 310 may be retrieved from the container radio frequency identification tag 110s and the package radio frequency identification tag 310 respectively. In a step 1130 the computer 210 may be operable to hash the UIDs of the container radio frequency identification tags 110. In a preferred embodiment, the UIDs of the container radio frequency identification tags 110 are ordered sequentially. The computer 210 may then be operable to retrieve from the database 220 the manufacturer's private key in a step 1140. In a step 1150 the computer 210 may be operable to produce a package signature from the UID of the package radio frequency identification tag 310, the private key, and the hashed aggregate UIDs of the container radio frequency identification tags 110. The hashed aggregate UIDs and the package signature may be written to the package radio frequency identification tag 310 in a step 1160.

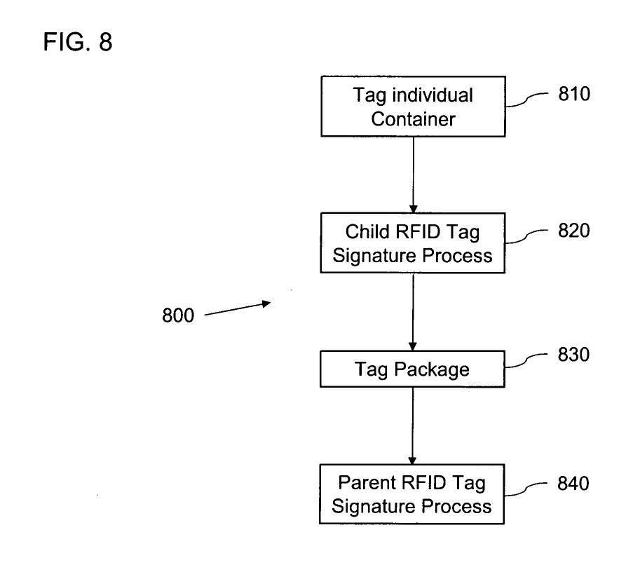

By employing methods 1000 and 1100, a parent-child relationship may be established between container signatures written to each container radio frequency identification tag 110 and the package signature written to the package radio frequency identification tag 310. These methods may be summarized by a method generally designated 800 (FIG. 8) in which in a step 810 each container 100 is tagged and in a step 820 each container radio frequency identification tag 110 is written with the container signature. In a step 830 the package 300 is tagged and in a step 840 the package radio frequency identification tag 310 is written with the package signature.

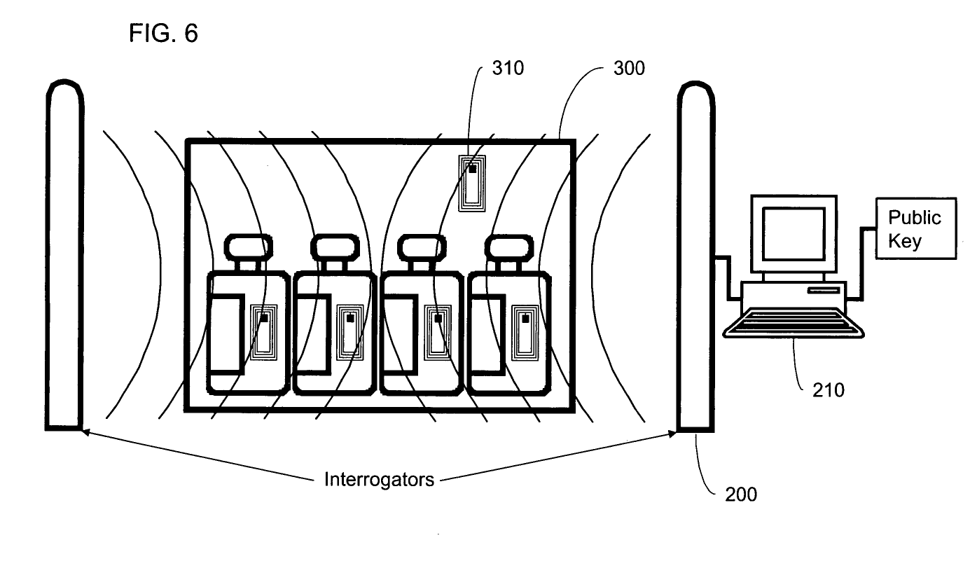

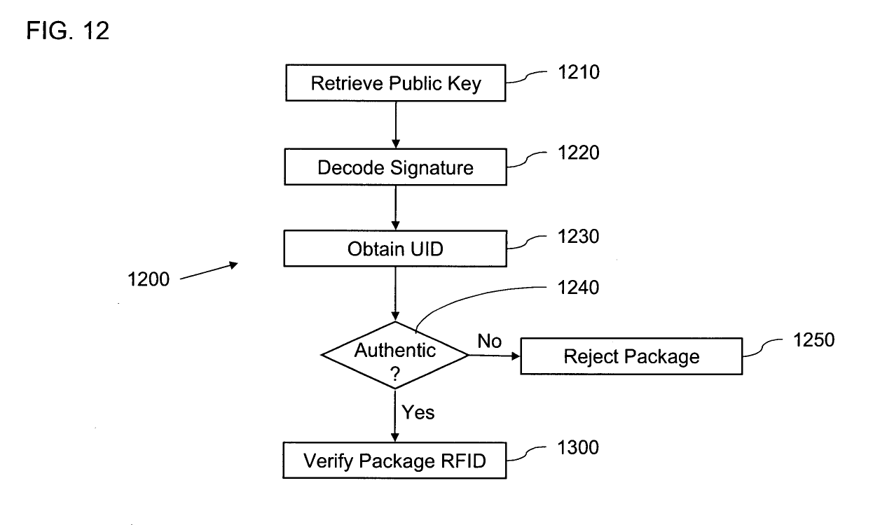

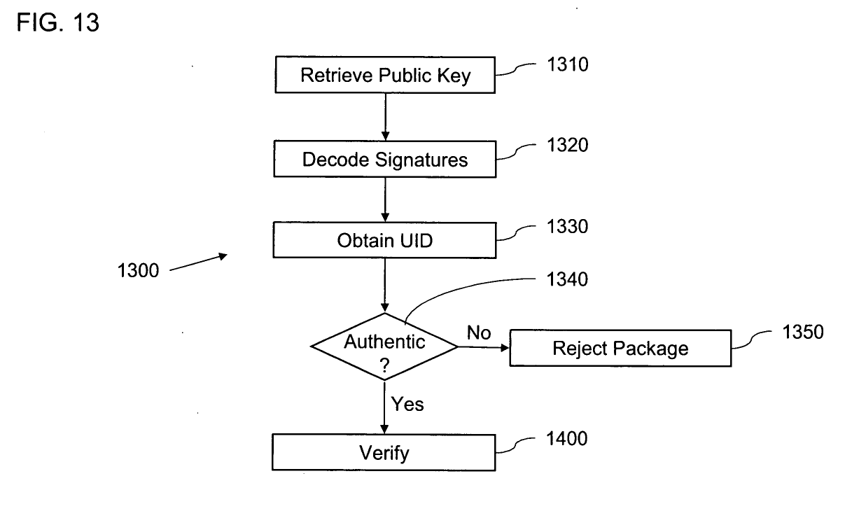

With reference to FIG. 6 and FIG. 12, in order to authenticate and verify the contents of package 300, each container radio frequency identification tag 110 may be authenticated by a method generally designated 1200. In a step 1210 a public key may be retrieved from the manufacturer. The container signatures for each container 100 may be decoded in a step 1220 to obtain the UID and product data from each container 100 at the time of manufacture in a step 1230. The obtained UID and product data at the time of manufacture may be compared to the container UID and product data in a step 1240. If the obtained UID and product data at the time of manufacture matches the container UID and product data for each container 100, then the package RFID tag 310 is authenticated by method 1300 (FIG. 13) as described herein. If the obtained UID and product data at the time of manufacture does not match the container UID and product data for each container 100, then the package 300 is rejected in a step 1250.

In order to authenticate the package RFID tag 310 and with reference to FIG. 13, a method generally designated 1300 may include a step 1310 in which the public key is retrieved from the manufacturer. The package signature may be decoded in a step 1320 to obtain the UID of the package radio frequency identification tag 310 and the hashed UIDs of the container radio frequency identification tags 110 at the time of manufacture. In a step 1330 the UID of the package radio frequency identification tag 310 and the hashed UIDs of the container radio frequency identification tags 110 within the package 300 may be obtained. In a step 1340 the obtained UID of the package radio frequency identification tag 310 and the hashed UIDs of the container radio frequency identification tags 110 at the time of manufacture may be compared to the UID of the package radio frequency identification tag 310 and the hashed UIDs of the container radio frequency identification tags 110 within the package 300. If the obtained UID of the package radio frequency identification tag 310 and the hashed UIDs of the container radio frequency identification tags 110 at the time of manufacture match the UID of the package radio frequency identification tag 310 and the hashed UIDs of the container radio frequency identification tags 110 within the package 300, then in method 1400 the authenticity of the package 300 and the containers 100 may be verified. Otherwise, in a step 1350 the package 300 is rejected.

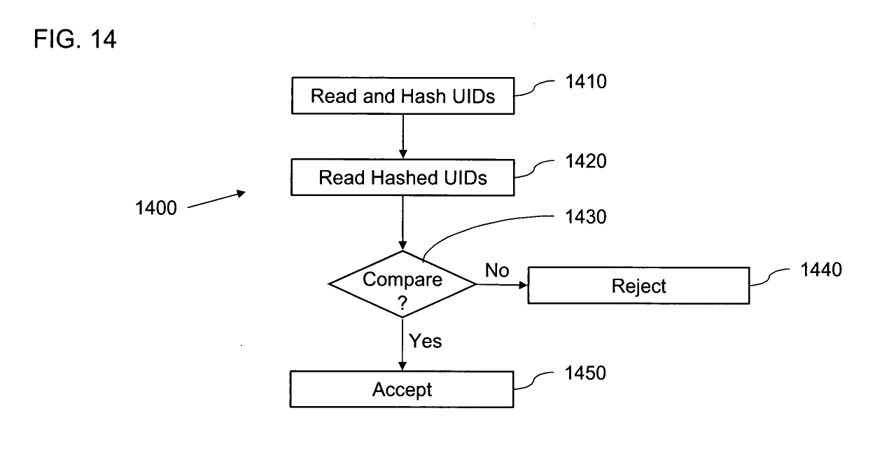

With reference to FIG. 14, a method generally designated 1400 may include a step 1410 in which all of the container radio frequency identification tag 110 UID are read and hashed. In a step 1420 the hashed container UIDs are read from the package radio frequency identification tag 310. The hashed container UIDs may be compared in a step 1430. If the hashed container UIDs compare, then in a step 1450 the package 300 is accepted, otherwise in a step 1440 the package 300 is rejected.

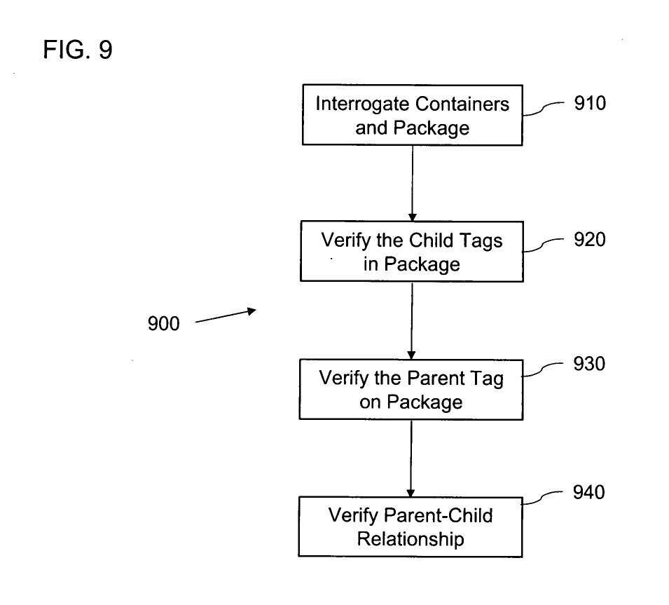

In accordance with an aspect of the invention, a verification method generally designated 900 (FIG. 9) may include a step 910 in which each container radio frequency identification tag 110 and the package radio frequency identification tag 310 may be interrogated. In a step 920 each container radio frequency identification tag 110 may be verified and in a step 930 the package radio frequency identification tag 310 may be verified. Finally in a step 940 the parent-child relationship between the package radio frequency identification tag 310 and the container radio frequency identification tags 110 may be verified.

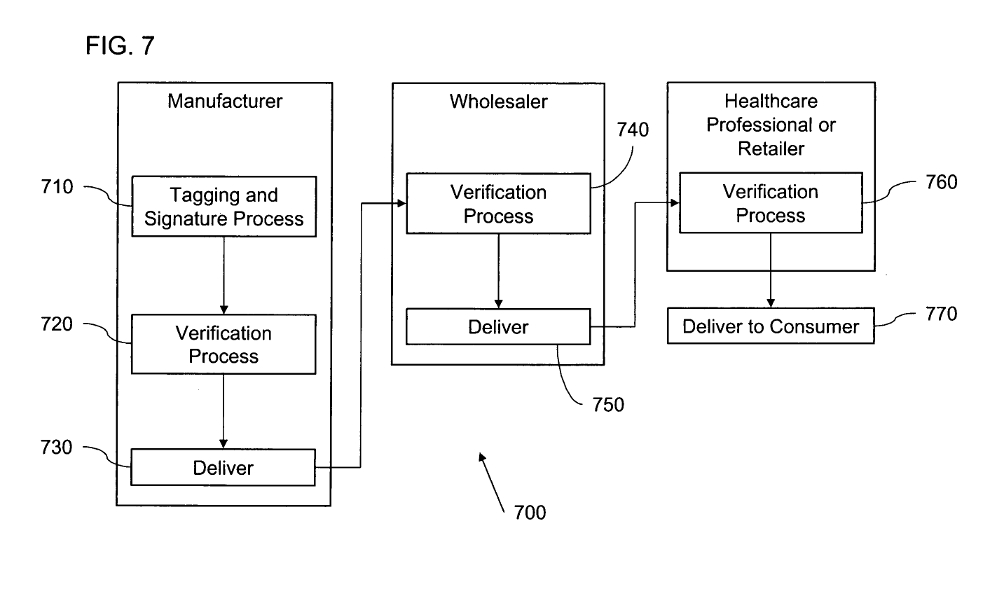

In another aspect of the invention and with reference to FIG. 7, a method generally designated 700 may include a step 710 in which a manufacturer may tag and write container and package signatures to a lot of products in accordance with methods of the invention. In a step 720 the containers and packages may be verified in accordance with methods of the invention. The lot may be delivered to a wholesaler in a step 730. In a step 740 the wholesaler may verify the containers and packages in accordance with methods of the invention. The lot may be delivered to a healthcare professional or retailer in a step 750. In a step 760 the healthcare professional or retailer may verify the containers and packages in accordance with methods of the invention. The product may be delivered to a consumer in a step 770.

Those skilled in the art will recognize that an extensive database of identification information is not required by the methods of the invention. In a case where the wholesaler, healthcare professional, and retailer have access to the manufacturer's public key, verification can be accomplished without accessing any database.

It should be understood, of course, that the foregoing relates to preferred embodiments of the invention and that modifications may be made without departing from the spirit and scope of the invention as set forth in the following claims.

1. A system for authenticating products delivered in each of a plurality of containers packaged in a package comprising:
a child tag attached to each container; and
a parent tag attached to the package, the child tags and the parent tag having a parent-child relationship.

2. The system as claimed in claim 1, wherein the parent tag and the child tags are radio frequency identification tags.

3. The system as claimed in claim 1, wherein each child tag comprises a container UID, a product data, and a signature determined from a container UID, a private key, and the product data.

4. The system as claimed in claim 3, wherein the parent tag comprises a package UID, the container UIDs, and a signature determined from the container UIDs and the private key.

5. The system as claimed in claim 4, wherein the container UIDs are hashed.

6. The system as claimed in claim 1, wherein each child tag uniquely identifies each container to which it is attached.

7. The system as claimed in claim 1, wherein the parent tag uniquely identifies the package containing the tagged containers.

8. The system as claimed in claim 1, wherein the parent tag uniquely identifies each tagged container packaged therein.

9. The system as claimed in claim 1, wherein the parent tag and the child tags are uniquely identified through the parent-child relationship.

10. The system as claimed in claim 1, wherein each child tag is signed.

11. The system as claimed in claim 10, wherein each child tag is uniquely identified with a signature.

12. The system as claimed in claim 1, wherein the parent tag is signed.

13. The system as claimed in claim 12, wherein the parent tag is uniquely identified with a signature.

14. A method for authenticating products delivered in each of a plurality of containers packaged in a package comprising the steps of:
tagging each container with a child tag; and
tagging the package with a parent tag, the child tags and parent tag having a parent-child relationship.

15. The method as claimed in claim 14, wherein the parent tag and the child tags are radio frequency identification tags.

16. The method as claimed in claim 14, wherein each child tag comprises a container UID, a product data, and a signature determined from the container UID, a private key, and the product data.

17. The method as claimed in claim 16, wherein the parent tag comprises a package UID, the container UIDs, and a signature determined from the container UIDs and the private key.

18. The method as claimed in claim 17, wherein the container UIDs are hashed.

19. The method as claimed in claim 14, wherein each child tag uniquely identifies each container to which it is attached.

20. The method as claimed in claim 14, wherein the parent tag uniquely identifies each tagged container packaged therein.

21. The method as claimed in claim 14, wherein the parent tag and the child tags are uniquely identified through the parent-child relationship.

22. The method as claimed in claim 14, further comprising signing each child tag.

23. The method as claimed in claim 22, wherein each child tag is uniquely identified with a signature.

24. The method as claimed in claim 14, further comprising signing the parent tag.

25. The method as claimed in claim 24, wherein the parent tag is uniquely identified with a signature.

26. A method for authenticating containers packaged in a package comprising the steps of:
tagging each container with a container tag;
writing a container signature to each container tag;
tagging the package with a package tag; and
writing a package signature to the package tag, the container tags and the package tag having a parent-child relationship.

27. The method as claimed in claim 26, further comprising interrogating the container tags and package tag, verifying the authenticity of the container tags, verifying the authenticity of the package tag, and verifying the parent-child relationship between the container tags and the package tag.

28. The method as claimed in claim 27, wherein the package is rejected if any of the container tags is not authentic.

29. The method as claimed in claim 28, wherein the package is rejected if the parent tag is not authentic.

30. The method as claimed in claim 29, wherein the package is rejected if the parent-child relationship is not authentic.
